(19) United States
(12) Patent Application Publication
(10) Pub. No.: US 2024/0176593 A1
(43) Pub. Date: May 30, 2024

(54) System and method for API driven rapid application development and execution

(71) Applicant: Junjie Leng, Tampa, FL (US)

(72) Inventor: Junjie Leng, Tampa, FL (US)

(21) Appl. No.: 18/500,824

(22) Filed: Nov. 2, 2023

Related U.S. Application Data
(60) Provisional application No. 63/382,501, filed on Nov. 5, 2022.

(51) Int. Cl. G06F 8/20

(52) U.S. Cl. CPC G06F 8/22

(57) ABSTRACT

The present disclosure relates to a system and method for API driven rapid micro service application development and execution. The system allows developers to define business requirements into flow definition files, includes an event engine to handle and execute the logic by dynamically correlating the definition files and API protocol specifications. The system incorporates plugins for each protocol to process the specification and communicate with other components. When acting as event handler for specific process flow, the system decodes the packets, associates the data with corresponding event handler and application flow, converts into the format per conversion rules defined in the definition files, executes the actions and transitions defined in the process flow per the application's business requirements. The system enables developers or business analysts develop application via visualized user interface, without the need of writing codes in programming languages or compiling into binary executable files.

### PRIORITY CLAIM

This non-provisional utility patent application claims priority to a U.S. Provisional application having Ser. No. 63/382,501 filed on Nov. 5, 2022.

### TECHNICAL FIELD OF THE INVENTION

The present subject matter described herein, in general, relates to application development and execution, by dynamically connecting API specifications with application process flows associated with actions and transition attributes, theretofore to implement the required service logic with less or no code development. Both API specifications and process flow definitions are presented as human readable format.

### DESCRIPTION OF RELATED ART

Modern software applications designed with microservice architecture increasingly use Application Programming Interfaces (APIs) as the protocols to programmatically interact with other services or components. An API specification can be referred to as a contract between the communication entities, where it defines the data format, values, request and response message types in order to exchange the data among the API consumers or clients and producers or servers.

Various forms of API specifications are defined by different organizations, aiming to simplify and standardize the application development by unifying the message format, parameters, headers, data, data schema. For example, A REST (representational state transfer) API (also known as RESTful API) is an application programming interface that conforms to the constraints of REST architectural style and allows for interaction with RESTful web services. The OpenAPI Specification (OAS) defines a standard, programming-language agnostic interface to RESTful APIs in a both human and machine understandable format. It is used to describe the API's contract during the design phase, to generate documentations, generate various codes in different programming languages (such as Java, Python, golang, Javascript, etc.) or import into applications such as API gateways, Application monitoring systems for configurations. A GraphQL specification as a different way in building API where it defines a human-readable Schema Definition Language (SDL) to describe the capabilities and requirements of data models to be used by client-server applications, and differentiates itself from REST API where it enables accessing any or all data points through one single API endpoint. A Protocol Buffers (Protobuf) specification describes the data structures and services for storing data or interchanging information with applications via Remote Procedure Call (RPC) method over networks.

When software developers develop the application based on the provided contract, namely the API specifications, they usually leverage code generation tools to generate server-side and client-side boilerplate codes in various programming languages. Such development practice becomes cumbersome as it introduces repetitive codes, generated codes usually are difficult to maintained along with the technology evolution, some codes even cannot be modified. The developers need to work with extra care in adding or modifying the codes that are specific to the requirements. Codes and handlers for additional functionalities, such as security protection, exception handling, observability and traceability, also need to be implemented repetitively in order to make the applications to be production ready, posing higher demands on the developer skills and experiences, increases the labor effort in both development and quality assurance testing, makes it difficult for citizen developers to develop a quality application fully complaint with the required API specification.

### SUMMARY OF THE INVENTION

The present disclosure relates to a system and method for API driven rapid application development and execution. The system includes an event engine to handle events and execute the application logic for each event based on actions and steps defined via configuration files. The application contracts in the form of API specification are loaded directly into the system in the form of configuration files without the need for code generations, the system incorporates plugins per each API protocol to process the corresponding application layer definitions such as message types, parameters, headers, data, data schema. The system validates the contract definitions, converts the definitions into corresponding events and actions, and injects into the event engine, whereas the event engine monitors for the specified events, and triggers the process to execute the actions defined in the process flow definition files. The actions for each process flow are chained together in the form of Directed Acyclic Graph (DAG), a directed graph with no directed cycles, where each action is a node in the graph, and transitions among actions are defined as edges. The transition attributes, such as when and under what conditions, are calculated statically or dynamically based on the event or data variables, thus the DAG graph reflects the actual application flow, with support of if-else, switch-case, loop-iteration, exception handling, thus can fulfill all different logic control needs, but compared with the traditional way the programmer writes the code in actual programming language, the invention allows the programmer or citizen developer to implement the logic via intuitive design interfaces where they can drag and drop nodes and connect the nodes together by adding conditions or logic control nodes as configuration items, without the need to writing actual codes.

In one embodiment, the system identifies the application to function as the consumer of the contract, retrieves the client side contract definitions as activity or actions to be triggered by the event engine, collects and transforms the parameters into the client side request content, sends the request packet to the server with additional headers/attributes further defined in the contract, and upon receiving the response packet(s) returned from the producer, the system validates the response packet(s) against the contract, if error or exception happens, the system executes the error or exception handling logic defined in the contract or defined in the application definition file; otherwise, it executes the process flow defined in the configurations together with the input values to complete the current action handling, thus the event engine can move to process next action(s) defined in the process flow definition files.

In one embodiment, the system identifies the application to function as the producer of the contract, retrieves the server-side contract definitions as event triggers and injects those event definitions into the event engine. The event engine then monitors the corresponding event, such as establishing a server socket to wait for request coming over the network. Upon reception of incoming packets, it decodes the packets, associates the packets with corresponding event handler based on attributes in the decoded result, validates the decoded request data values against the API data schema, converts the request data into the format based on the conversion mapping rules defined by the developer, and then executes the defined actions by following the action transition conditions, where the actions are defined in the application definition files and linked together to form a Directed Acyclic Graph (DAG), the output of one action can become the input of the following actions, as such, after all the required actions are executed, the Event engine returns the execution result to the event handler where the event handler further validates the result data against the response data schema, generates response packet(s) with the resulting data and sends back to the requesting party when all steps are succeeded, otherwise it generates error response and send back to the requesting party.

In one embodiment, the system incorporates a plugin mechanism to extend the system capabilities without the need to recompile and redistribute the system runtime binary files, and reduce the execution footprint as plugin won't need to be loaded into memory for execution unless it is specifically used by the application definition files. Each contract can be implemented as one or more contract plugins, e.g., an OpenAPI plugin to process the OpenAPI specification, a GraphQL plugin to support the GraphQL specifications, while a Protobuf plugin to handle the Protobuf protocol. There could be multiple plugins for same protocol but with further divided function, e.g., an OpenAPI Consumer plugin may only process the OpenAPI specification on the consumer side, while an OpenAPI Producer plugin may process the OpenAPI specification on the producer side. Extra functionalities can also be implemented as plugin, e.g., a security augmented OpenAPI plugin provides further security enhanced features on top of the OpenAPI server plugin, a generic rate limiting plugin provides request throttling for all server-side plugins.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts an exemplary microservice oriented system architecture, whereas the user management application is an exemplary component implemented in accordance with described embodiments;

FIG. 2 depicts exemplary user management application definitions files in accordance with described embodiments;

FIG. 3 depicts an exemplary application process flow composed of actions connected as Directed Acyclic Graph (DAG), in accordance with described embodiments;

FIG. 4 depicts an exemplary application sequence diagram for messages exchanged among the relevant microservice components, in accordance with described embodiments;

FIG. 5 presents an illustrative flowchart for system initialization in processing and connecting the API specifications with the process flow definitions, in accordance with described embodiments;

FIG. 6 presents an illustrative flowchart for a producer API handler process in fulfilling the application logic in a generic mechanism without developing codes for that specific application logic, in accordance with described embodiments;

FIG. 7 presents an illustrative flowchart for a consumer API handler process in fulfilling the application logic in a generic mechanism without developing codes for that specific application logic, in accordance with described embodiments;

FIG. 8 presents an illustrative flowchart for a synchronized process of consumer API handler in waiting and processing the response packet, in accordance with described embodiments;

FIG. 9 presents an illustrative flowchart for an asynchronized process of consumer API handler in processing the response packet, in accordance with described embodiments;

FIG. 10 depicts a functional block diagram illustration of a computer hardware platform to host and execute the application engine, consistent with an illustrative embodiment.

FIG. 11 presents an exemplary flowchart designer user interface allowing the developer to visually compose flowchart by dragging and dropping nodes, connecting the nodes, defining the parameters for each node based on the business logic for each flow.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure relates to a system and method for API driven rapid application development and execution. The system includes an event engine to handle events and execute the application logic for each event based on actions and steps defined via configuration files. The application contracts in the form of API specification are defined as one or more configuration files, the system incorporates plugins per each contract type to read the application contracts and retrieve the corresponding definitions such as message types, parameters, headers, data, data schema. The system validates the contract definitions, converts the definitions into corresponding events and actions, and injects into the event engine, therefore the event engine can monitor those defined events, and trigger the process to execute the actions defined in the process flow definition files.

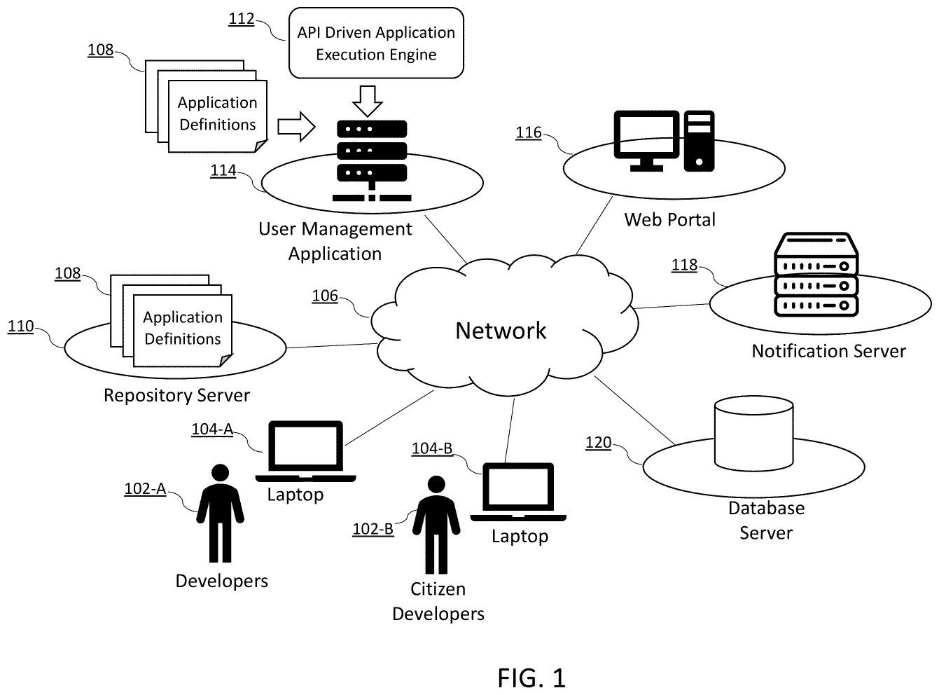

FIG. 1 depicts an exemplary microservice oriented system architecture, whereas the user management application is an exemplary component implemented in accordance with described embodiments. A microservice architecture is an architecture pattern, somewhat distinguished from traditional monolithic architectural styles in which microservice presents the application as a collection of loosely coupled services. Each service is a fine-grained self-contained piece of business functionality, and communicates with external or internal components via clear and lightweight interfaces or protocols. A microservice application could include multiple components or services, each providing its specific logic but usually need to interface with other components. The benefit of decomposing an application into different smaller services is that it improves modularity. This makes the application easier to be read, developed, tested, and become more resilient to architecture erosion. APIs are defined as the contract for related components to communicate with its peers for required business logic. The component that implements the API to provide as a service to other components is defined as an API provider, while the component that uses the API and work as client to consume the service from other components is an API consumer. In case a component implements multiple API specifications, it can function as API provider for one API, while at the same time function as the API consumer for another API.

According to one embodiment, an exemplary development environment for microservice oriented system architecture is illustrated, in which the system provides a user management functions that provide the user create, update, deletion and password reset functions. A development environment for the User Management Application 114 is communicably interfaced with a plurality of systems, such as Developer 102-A's Laptop 104-A, Citizen Developer 102-B's Laptop 104-B, Repository Server 110, Web Portal 116, Notification Server 118, Database Server 120, through the communication network 106. The Repository Server 110 is a storage location for software packages, metadata, definition files and etc., as version control server that tracks all the change history of the source codes and definition files. The Developers 102-A, Citizen Developers 102-B writes or modifies the Application Definitions 108 and commit to the Repository Server 110 for version control.

As depicted here, the User Management Application 114 includes the API Driven Application Execution Engine 112 as well as the Application Definitions 108 files that can be managed via the Repository Server 110, and stores in its local storage, the Application Definitions 108 include all the definitions files specific to the User Management Application. The Execution Engine 112, as a common, non-business-logic-oriented application engine, fulfills the specific User Management business logics by reading and processing the configurations defined in the Application Definitions 108 files. In this way, the business logics are implemented via configurations, requiring no codes or less codes to be developed by the developer(s), the Application Execution Engine 112 is the execution engine for the No-Code Development Platform (NCDP) or low-code development platform (LCDP).

As noted above, the User Management Application 114 leverages the Application Execution Engine 112 that executes the definitions defined in the User API specification, and functions as API provider for the Web Portal 116. As an exemplary use case, the Application Execution Engine 112 also executes the Notification API specification and functions as API consumer to interface with the Notification Server 118 for email/short message notification to the end user. The Application Execution Engine 112 executes the process flow definitions that need to interface with the Database Server 120 for user records related operations such as retrieval, insertion, update or deletion. Such databases include various database system types including, for example, a relational database system such as MySQL, PostgreSQL, or a non-relational database system such as MongoDB, CouchDB, according to certain embodiments.

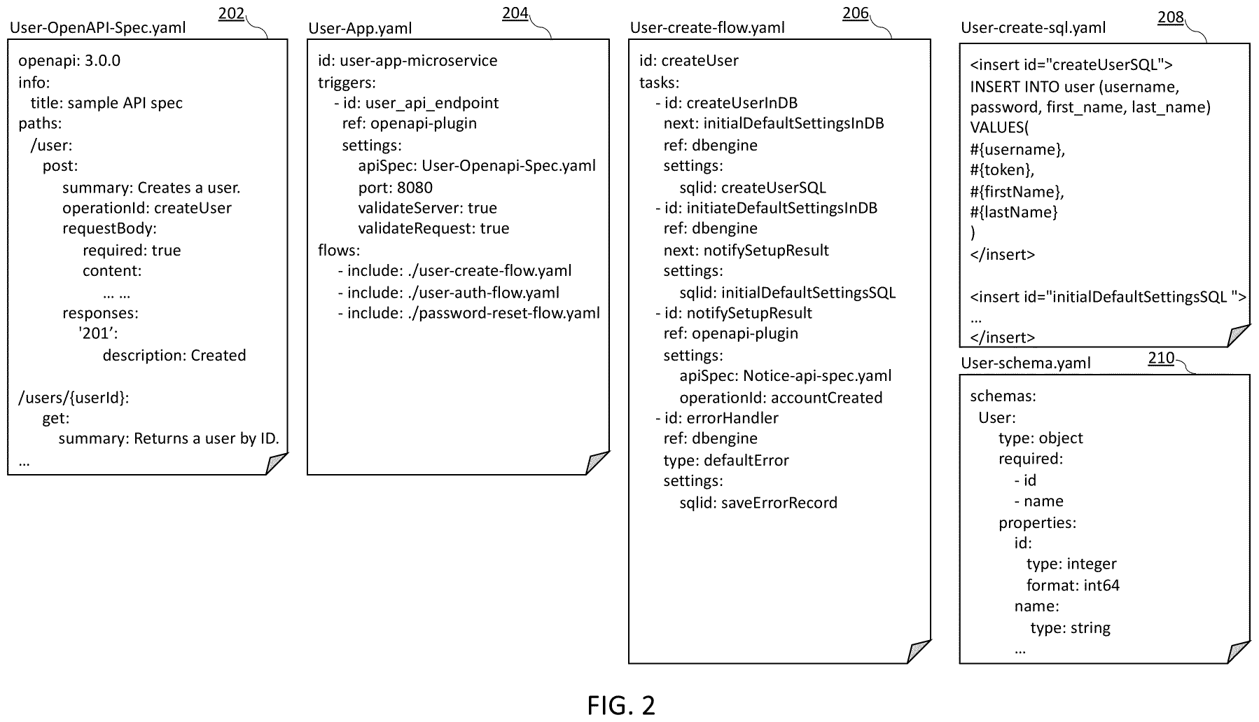

FIG. 2 depicts exemplary user management application definitions files in accordance with described embodiments; The exemplary application definitions to comprise the user management application logic includes: 1) Open API specification with the exemplary name of “User-OpenAPI-Spec.yaml” 202; 2) User Management Application master configuration with the exemplary name of “User-App.yaml” 204; 3) Flow definitions for specific logic, with the exemplary name of “User-create-flow.yaml” 206; 4) the Structured Query Language (SQL) statements files required by the action defined in the Flow definitions, with the exemplary name of “User-create-sql.yaml” 208; 5) the data schemas to be used by related definitions, with the exemplary name of “User-schema.yaml” 210. The exemplary definition files follow the YAML specifications with uses .yaml as the file extension name. YAML (stands for Yet Another Markup Language) is a popular data serialization language that is human-readable and often used for writing configuration files. It will be apparent, however, to one skilled in the art that other configuration format can also be leveraged, for example, JavaScript Object Notation (JSON), Extensible Markup Language (XML), Specification and Description Language (SDL), or even free-form text documents supported by the application, and the like.

An API definition may be written or otherwise formulated in accordance with one or more API specifications. For example, an API definition file compliant with the OpenAPI specification describes operations that to be implemented by a business process (e.g., a method or process performed for or on behalf of an entity and its data-driven processes), and includes inputs, outputs, response codes, data schemas that include data format representing one or more business objects. The exemplary “User-OpenAPI-Spec.yaml” is defined by following the OpenAPI specification, whereas an exemplary operationId of “createUser” is defined with POST as the HTTP invocation, “/user” as the Request URI, together with the Request Body, Responses format etc., the section defines the format that can be used by both the API Provider and API Consumer components. Beyond the regular use of the operationId of “createUser” in an OpenAPI endpoint, according to described embodiment, the operationId is further referenced by the process flow definition file, as shown in the example “User-create-flow.yaml” 206, the flow id is defined as same of operationId “createUser”, meaning that in the case the application functioning as an API Provider, when the application receives HTTP invocation to the operationId of “createUser”, the Application Execution Engine 112 described in FIG. 1 can process the HTTP request, and execute the flow actions defined in the flow definitions whose flow id is “createUser”. It will be apparent, however, to one skilled in the art that the operationId and flowId are not necessarily to be in the same value, the Application Execution Engine can employ certain mapping mechanism to maintain the relationship between the operation Id and flow Id. As example, the flowId can be statically included with prefix or suffix; or the mapping can be stored in a storage disk or database thus the Application Execution Engine can load such mapping table when application is booted, or dynamically find the mapping when needed.

As depicted in the exemplary figure, the User Management Application master configuration with the exemplary name of “User-App.yaml” 204 defines the key components for the Application Execution Engine to process. The “triggers” section defines a trigger with “user_api_endpoint” id, which uses “openapi-plugin” plugin as defined in the “ref” attribute to implement the OpenAPI Provider function. More specific settings are defined in the “Settings” attributes, whereas the previously mentioned OpenAPI specification's filename and path are defined in the “apiSpec” attribute, other attributes are also defined to describe the OpenAPI Provider functionalities, such as the Provider should listen on port 8080, and validate both the request and server info as both attributes “validateServer” and “validateRequest” are all set to true. The exemplary attributes mentioned are for reference purpose, it is not necessary and by no means to enumerate all the attributes.

The depicted definitions file 204 further includes the “flows” section, in which multiple flows are defined in separated files, while the exemplary “User-create-flow.yaml” 206 is included as one of the items. In one embodiment, the actual flow definition files are defined in a separated file, thus a “include” attribute is defined to refer to the file location of the actual flow. In another embodiment, the actual flow definitions can be directly put under the “flows” section, a format compliance with YAML syntax and supported by YAML libraries and processors. Those who are skilled in the art can recognize that all the attributes used here are for reference purpose, they can modify the format and use different attributes, but not deviate from the main spirit of the disclosed art.

Now moved onto the exemplary flow definition file “User-create-flow.yaml” 206, whereas 4 tasks are defined in the “tasks” section, each task is defined with an identifier and corresponding settings, in each setting, the “ref” attribute define the plugin or module that can be executed for corresponding functions, the “next” attribute is one of the action transition attributes defining the next action(s) to be executed when the current action return successful results. more advanced transition attributes such as loop-iteration, if-else, switch-case, exception handling, sub-flow etc. can also be used to design much sophisticated business logic, all such transition attributes are used to link the actions together to form a Directed Acyclic Graph (DAG), a directed graph with no directed cycles, in which actions are defined as nodes and transition among actions are defined as edges. Other attributes such as “sqlName”, “apiSpec” are specific for each different module, more attributes can be defined and supported based on each module's actual implementation. The exemplary attributes mentioned are for reference purpose, it is not necessary and by no means to enumerate all the attributes. It should be apparent, however, to one skilled in the art that the actions are not necessarily to be all native functions of the application, they can be implemented via external plugins and loaded during the application start phase.

The depicted exemplary SQL statement file 208 includes multiple Structured Query Language (SQL) statements, with “id” as identifier defined for each statement. SQL is a standardized programming language used to manage relational databases and perform various operations on the data inside them. Each statement defines a specific database operation using the SQL syntaxes supported by the database, the below example defines an INSERT INTO statement which is to insert a new user record into the table, where several parameters #{username}, #{token}, etc. are to be supplied and derived dynamically during the execution time. Such statement is called a parameterized query, in which placeholders ‘#{ . . . }’ are used for parameters and the parameter values are supplied at execution time. According to one embodiment, when the application requires to perform certain operation(s) into the database, the developer can write the related database operation with corresponding SQL statements or parameterized SQL queries, and define the database operations as actions in the process flows. When the Application Execution Engine executes the process flow, it supplies the related parameter values from various locations, e.g., from the API requests, from output values from previous action, from system or memory values, etc., validates and formats the values thus can replace those placeholders defined in the SQL statement file, and executes it against the specified database. As one embodiment, XML is used in the exemplary SQL statement file format. According to another embodiment, JSON, YAML, INI, etc. can be used as the SQL statement file format.

<insert id=″ createUserSQL″>
INSERT INTO user (username, password, first_name, last_name)
VALUES(
#{username},
#{token},
#{firstName},
#{lastName}
)
</insert>

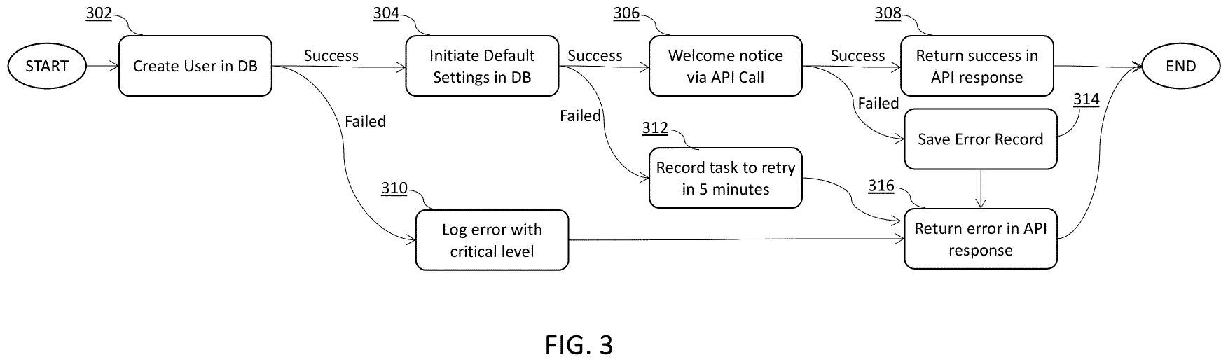

FIG. 3 depicts an exemplary application process flow composed of actions connected as Directed Acyclic Graph (DAG). The flow defined in the “User-create-flow.yaml” 206 flow definition file in FIG. 2 is used as example to illustrate the transitions across different actions based on each action's output result and conditions. The flow starts with the task 302 “Create User in DB”, corresponding to the task “createUserInDB” defined in “User-create-flow.yaml” 206, which takes the body of the HTTP POST whose operationId is createUser, converts them into fields required by the createUserSQL statement, and executes the populated createUserSQL statement to the database. The action is to create a new user record (including fields of username, token, first_name, last_name, etc.) in the database. Upon successful result, the flow engine is then transitioned to execute the task 304 “Initiate Default Settings in DB”, otherwise, it should go to the failed route and execute the task 310 “Log error with critical level” and then move to the node 316 “Return error in API response” to close the flow handling. Similarly, the task 304 initiates default settings for the newly created user in the database, by calling the database with a different SQL statement defined as “initialDefaultSettingsSQL”. If task 304 succeeds, the flow engine moves on to task 306 “Welcome notice via API Call”, whereas it works as API consumer and uses the operationId: accountCreated defined in the Notice-api-spec.yaml API specification. If task 304 fails, the flow engine then proceeds to task 312, whereas it records the task in the database and some other components can monitor it and retry in 5 minutes. If task 306 succeeds, the flow engine then moves to task 308, where it returns a successful result in the API response back to the API requestor and closes the process flow. Otherwise, the task 314 is executed to save the error record and then task 316 is triggered to return an error response back to the API requestor.

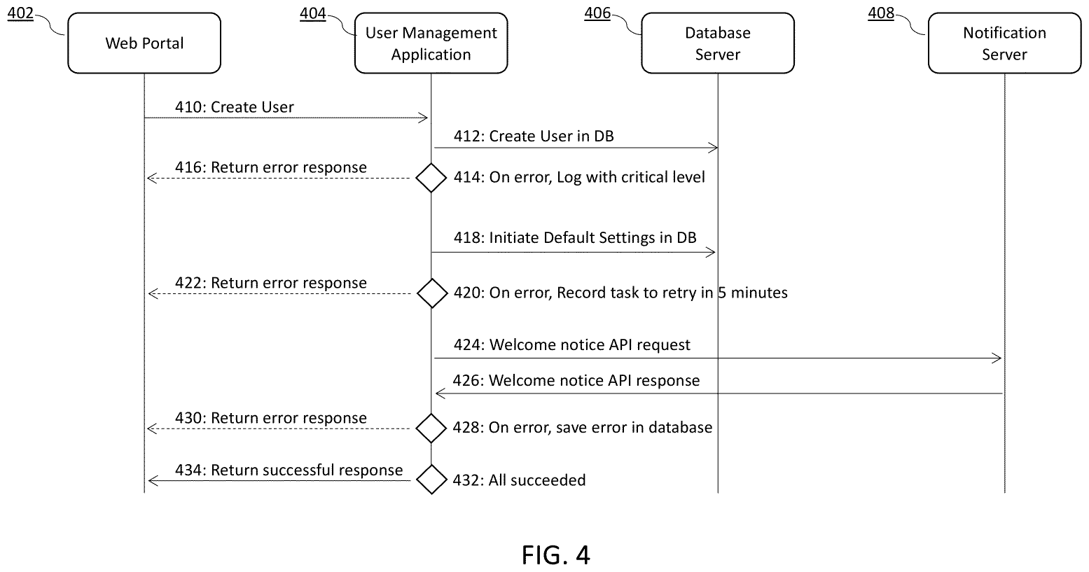

FIG. 4 depicts an exemplary application sequence diagram for messages exchanged among the relevant microservice components. This sequence diagram continues use the aforementioned User-create-flow as example, and presents the interactions among the 4 microservices components mentioned in FIG. 1: Web Portal 402, User Management Application 404, Database Server 406 and Notification Server 408. Imagine in a scenario that a web portal user fills in his/her information and clicks the submit button to register as a new user, upon receiving the submit event, the Web Portal 402 validates the values the user submits, and generates 410: Create User API request towards the User Management Application 404. The User Management Application 404 validate the API request data and interfacing with Database Server 406 for step 412: Create User in DB. Those who are skilled in the art can recognize that all the steps and error handling follow the similar descriptions introduced in the previous paragraph, for the sake of concise, the remaining steps can be easily inferred based on each step's name defined in the Figure.

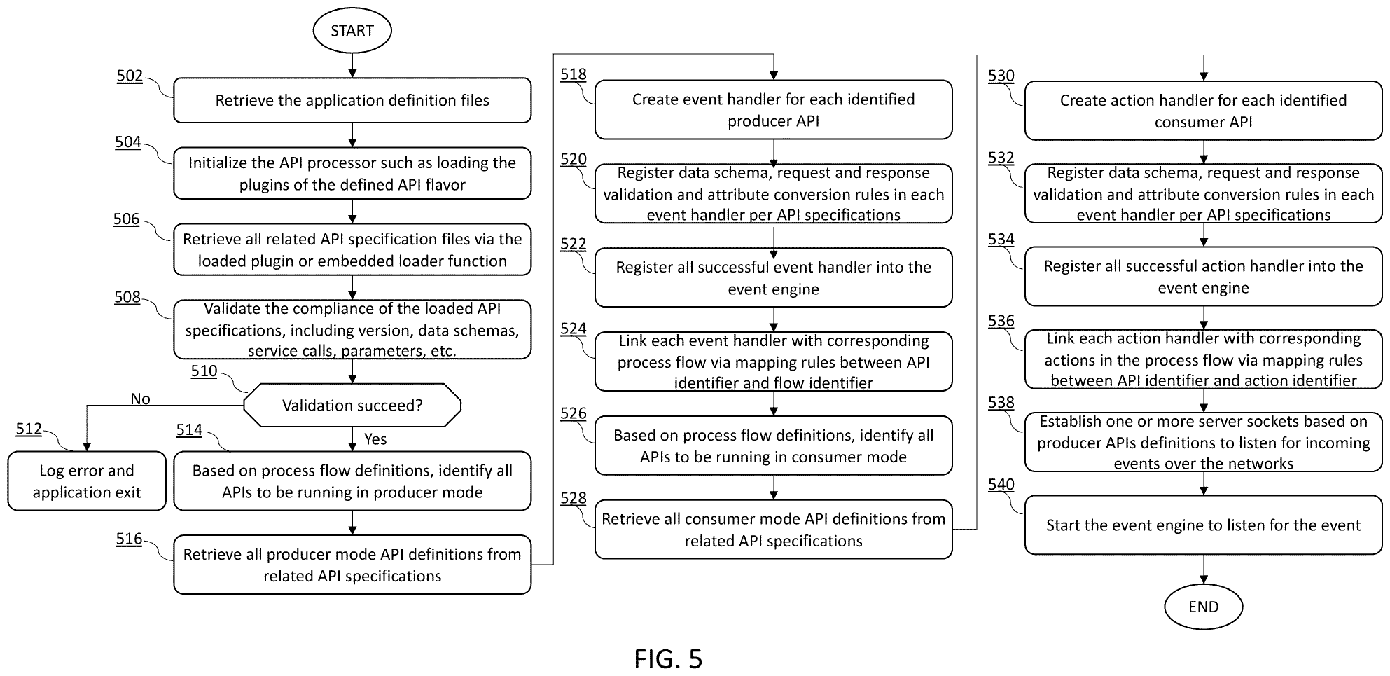

With the foregoing overview of the example architecture in FIG. 1, example definitions files in FIG. 2 and example process flow in FIG. 3, it may be helpful now to consider a high-level discussion of an example process. To that end, FIG. 5 presents an illustrative flowchart for system initialization in processing and connecting the API specifications with the process flow definitions.

FIG. 5 include a collection of blocks in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described blocks can be combined in any order and/or performed in parallel to implement the process. For discussion purposes, the FIG. 5 is described with reference to the example architecture of FIG. 1.

In accordance with one embodiment, when the Application Execution Engine (AEE) 112 in the exemplary architecture starts, at block 502, it retrieves the application definition files based on the parameters provided, and initialize the API/protocol processors such as loading the plugins of the defined API type per block 504. The API/protocol specifications can be defined in different types, e.g., Open Application Programming Interface (OpenAPI) Specification (OAS), Graph Query Language (GraphQL), Protocol Buffers (Protobuf), Simple Object Access Protocol (SOAP), Web Services Description Language (WSDL), RESTful API Modeling Language (RAML), Web Application Description Language (WADL), etc. thus accordingly a variety of protocol processors would be needed to support the syntax and processing of different protocol types. Each protocol processor can be implemented as module natively embedded with the application, or as external plugins loaded by the application during runtime. The AEE then uses the corresponding protocol processor to retrieve all related specification files at block 506, and validates at block 508 the compliance of the loaded specifications, including version, data schemas, service calls, parameters, etc. According to the validation results as shown at block 510, if the validation fails, the AEE logs the error per block 512 and elects to exit the application since there is error in the definitions that need people to correct before it can run.

Otherwise, the validation is passed, the AEE proceeds to step 514, whereas it starts to identify all APIs to be running in producer mode based on loaded process flow definitions in step 502. Normally the API definitions can include many APIs, some may not be required by the Application, thus finding out the minimal set of API endpoints or operations required based on the definitions in the “triggers” sections (as shown in the exemplary User-App.yaml 204) can help reduces the application's resource utilization in terms of CPU, Memory and even I/O. The AEE then retrieve all producer mode API definitions from related API specifications as described in step 516. For each identified producer API, instead of relying on the developers to use generated code to create corresponding handler in the program, the AEE dynamically creates event handler for each API per step 518, registers each event handler with corresponding data schemas, request and response validation and attribute conversion rules based on the values collected from the API specifications, as shown in step 522. The AEE then registers all the successfully created event handler into the event engine in step 522, and links each event handler with corresponding process flow via mapping rules between API operationId and flow identifier. As explained in FIG. 2, the AEE can employ certain mapping mechanism to maintain the relationship of the API operationId and flow identifier. For one embodiment, the 2 Ids can be exactly same; for one embodiment, the flowId can be the API operationId added with prefix “server-” or suffix “-server”; For another example, the names can be completely different but with mapping data stored in a storage disk or database thus the Application Execution Engine can load such mapping table and dynamically find the corresponding Id when needed.

Upon successful registered and correlated of the producer mode APIs with event handlers, the AEE proceeds to step 526 in identifying all APIs to be running in consumer mode. Similarly, only the minimal set of consumer API list are identified via the “tasks” sections, as exemplified in User-create-flow.yaml 206. It then retrieves all consumer mode API definitions from related API specifications in step 528, and then create action handler for each identified consumer API in step 530, and followed with step 532, it registers data schema, request and response validation and attribute conversion rules in each event handler per API specifications, and register all successful action handler into the event engine in step 534. After that, the AEE links each action handler with corresponding actions in the process flow via mapping rules between API identifier and action identifier. Thus, when an action is triggered, the AEE is able to find out which consumer API should be triggered and the request should be sent to which components. All these works are all implemented via automatic mapping and dynamic linking in the system resource, without the developer(s) to write codes or generate codes to implement the API functions.

Lastly, when all the previous steps are successfully completed, the AEE establishes one or more server sockets based on producer APIs definitions to listen for incoming events over the networks per step 538, and starts the event engine to listen for the event in step 540. As each event handler is now linking with corresponding API operation id, thus once the engine is successfully started, it listens for the incoming packet that is designated to specific API, and can call the corresponding event handler to process the event based on the mapping between the API operationId and process flowId aforementioned.

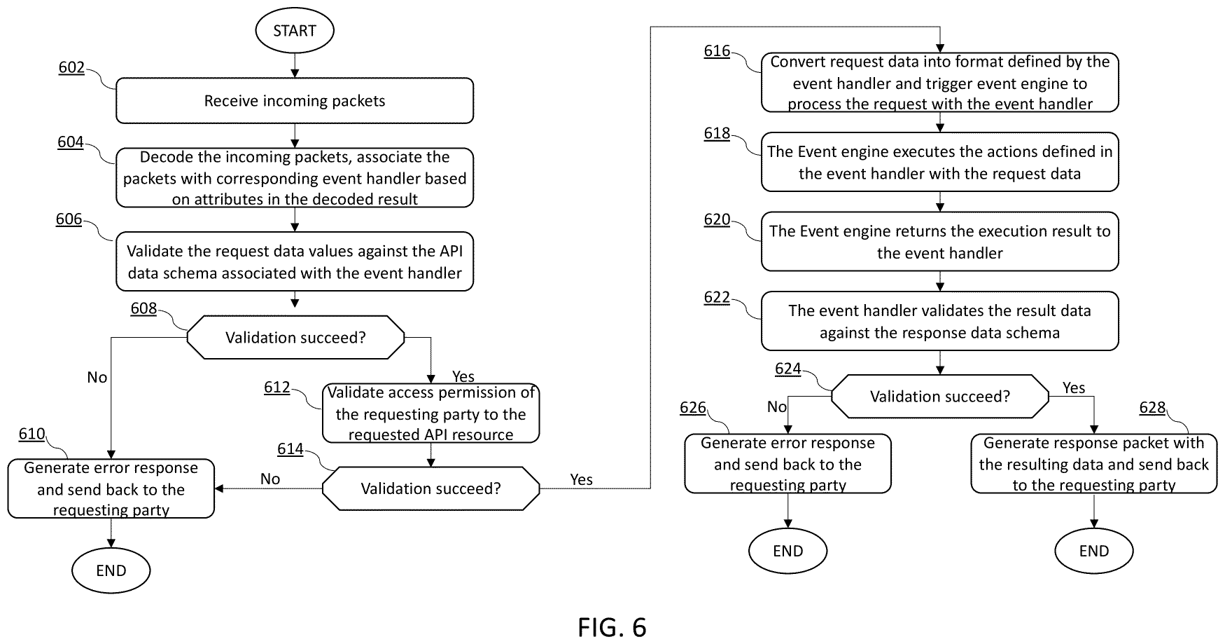

Reference now is made to FIG. 6, which illustrates a flowchart for a producer API handler process in fulfilling the application logic in a generic mechanism without developing codes for that specific application logic, in accordance with described embodiments. The process disclosed from block 602 to block 616 presents an exemplary message preprocess procedure of one embodiment of the disclosure. Based on the API type used in the Producer API, the corresponding API processor is loaded, during the AEE start phase, from plugin or as native function. When the API processor receives the incoming packets in block 602, decodes the packets, associates the packets with corresponding event handler based on attributes in the decoded result in block 604, the attributes used for the association normally include the HTTP invocation type (such as POST, GET, DELETE, etc.), Request URI, which are defined in the API specification and referenced as the operationId, since the AEE maintains the mapping of the operationId and FlowId as mentioned above, the AEE can then determines the corresponding event handler. Then at block 606, the AEE validates the decoded request data values against the API data schema registered with the selected event handler. If the validation is successful at block 608, the AEE continues to validate the access permission of the requesting party to the requested API resource as shown at block 612. The validation is failed at block 608 or block 614, the AEE generates error response and send back to the requesting party at block 610, and complete the process of this packet.

If the validations are all successful, the AEE continues to block 616 where it converts the request data into the format defined by the event handler, where the developer can define certain conversion mapping rules in the application definition files, the AEE triggers event engine to process the request with the event handler. Thus, the event engine starts to execute the actions defined in the event handler with the request data at block 618, where those actions are defined in the application definition files and linked together to form a Directed Acyclic Graph (DAG). Accordingly the output of one action can become the input of the subsequent actions, as such, after all the required actions are executed, the Event engine returns the execution result to the event handler at block 620, and again, the event handler validates the result data against the response data schema at block 622, if the validation is successful at block 624, the AEE generates response packets with the resulting data and sends back to the requesting party at block 628, otherwise it generates error response and sends back at block 626. The validations at block 606, 612, 622 are used as examples, a person skilled in the art within the technical scope disclosed in this application shall be able to add more validation steps without departing from the scope and spirit of the described embodiments, such validations could be native functions of the AEE, or be loaded from external plugins during the AEE start phase.

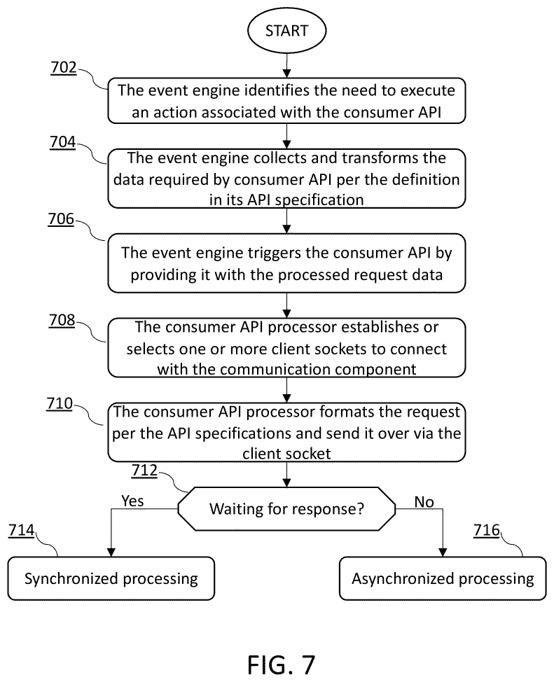

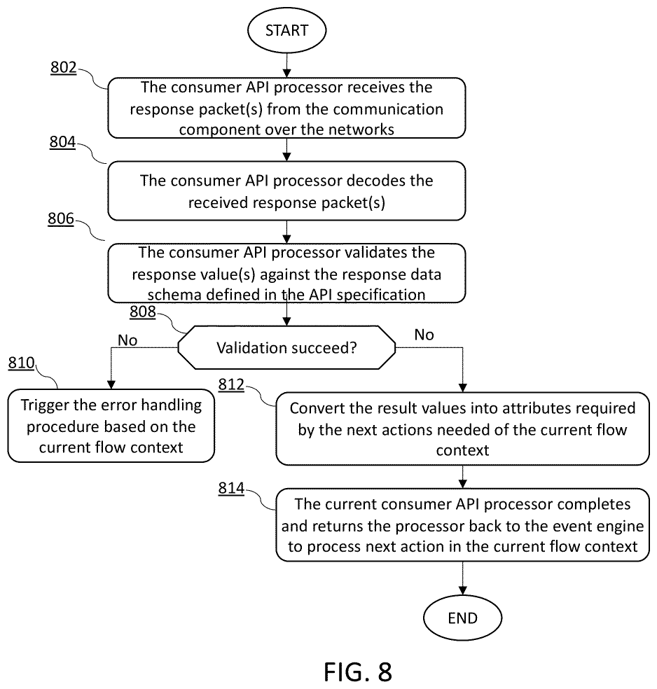

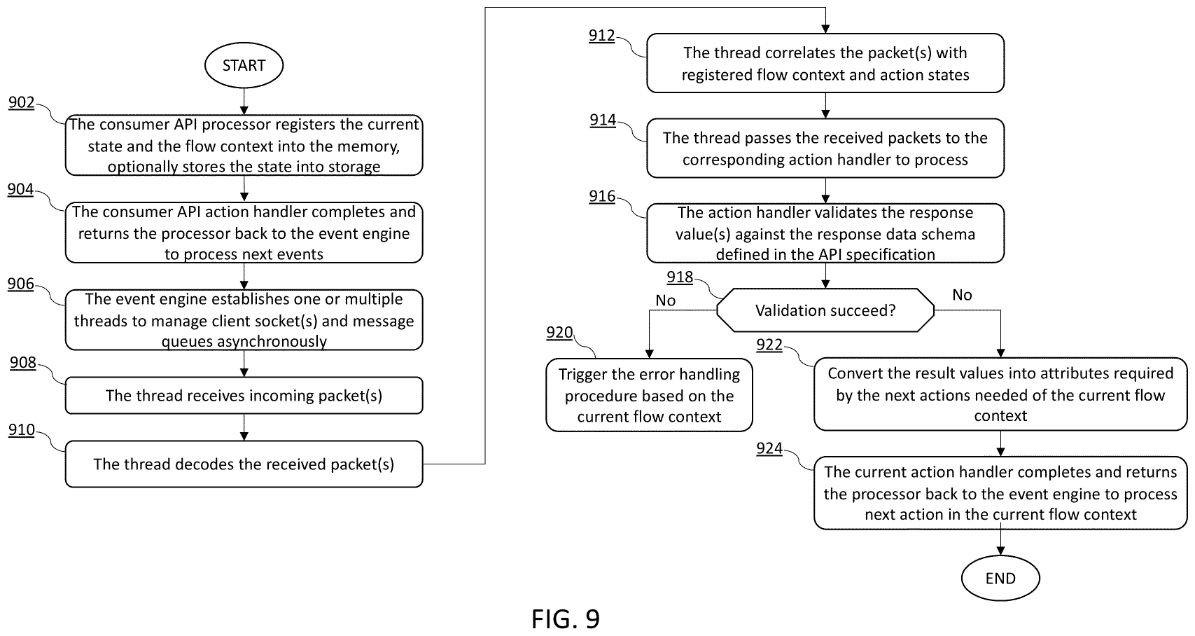

FIG. 7 presents an illustrative flowchart for a consumer API handler process in fulfilling the application logic in a generic mechanism without developing codes for that specific application logic, in accordance with described embodiments. At block 702, the event engine identifies itself that needs to execute an action associated with the consumer API, for example, one of the process flows requires to call an API to a remote component, a routine timer triggers the action to call the API, etc. At block 704, the event engine collects and transforms the data required by consumer API per the definition in its API specification, similar as the data conversion action at block 616, the transformation here follows similar approach where the developer can define certain conversion mapping rules in the application definition files. With the transformed data, the event engine triggers the consumer API processor by supplying the processed request data at block 706. The corresponding consumer protocol processor, either as embedded module or loaded from external plugin, establishes or selects one or more client sockets to connect with the communication component over the networks at block 708, formats the request per the protocol specifications and sends it over via the selected client socket at block 710. The next step depends on whether the current thread needs to wait for the response or not, as shown at block 712, based on the API specification or the specific application flow definition, which can be either synchronized processing at block 714 illustrated in FIG. 8, or asynchronized processing at block 716 illustrated in FIG. 9.

Reference now is made to FIG. 8, which presents an illustrative flowchart for a synchronized process of consumer API handler in waiting and processing the response packet, in accordance with described embodiments. As a synchronized process, the API processor waits until it receives the response packet(s) from the communication component over the networks at block 802, then decodes the received packet(s) as shown at block 804, and validates the response value(s) against the response data schema defined in the API specification per block 806. If the validation is failed, it triggers the error handling procedure based on the current flow context to complete the current handling as shown in block 810. Otherwise, it converts the result values into attributes required by the next actions of the current flow context at block 812 according to the conversion mapping rules defined for the current action, then the processor moves to block 814 where it completes and returns the processor back to the event engine to process next action in the current flow context.

FIG. 9 presents an illustrative flowchart for an asynchronized process of consumer API handler in processing the response packet, in accordance with described embodiments. To continue as an asynchronized process, at block 902, the consumer API processor needs to register the current state and the flow context into the memory, optionally stores the state into storage, thus the current action handler completes itself and returns the processor back to the event engine to process next events at block 904. At block 906, the event engine establishes one or multiple threads to manage client socket(s) and message queues asynchronously, here the timing of establishing the thread(s) is for illustration purpose, it should be apparent, however, to one skilled in the art that in common practice, such thread(s) are established in advance when the AEE starts. The thread receives incoming packet(s) at block 908, and decode received packet(s) at block 910. Then at block 912, it correlates the decoded packet(s) with registered flow context and action states, such correlation can be based on transaction identifier, or unique token that can be mapped uniquely to the registered flow context. After that, the thread passes the received packets to the corresponding action handler to process at block 914, the action handler validates the response value(s) against the response data schema defined in the API specification at 916. The remaining process of block 918, 920, 922, 924 are similar to that of block 808, 810, 812 and 814. Similarly, more validation steps or additional process blocks can be added without departing from the scope and spirit of the described embodiments, such validations or additional processes could be native functions of the AEE, or be loaded from external plugins during the AEE start phase.

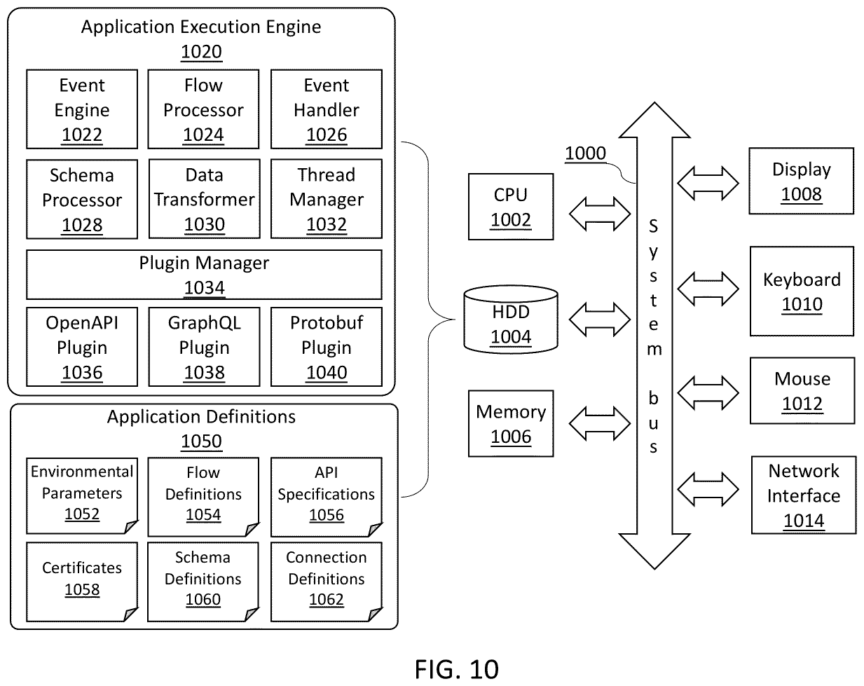

FIG. 10 is a functional block diagram illustration of a computer hardware platform that can communicate with various networked components, such as Laptops, Repository Server, Web Portal, Notification Server, Database Server, etc. as shown in FIG. 1. The computer platform may include central processing unit (CPU) 1002, hard disk drive (HDD) 1004, random access memory (RAM) and/or read only memory (ROM) 1006, display 1008, keyboard 1010, mouse 1012, and communication interface 1014, which are connected to a system bus 1000.

In one embodiment, the HDD 1004, has capabilities that include storing a program that can execute various processes, such as the Application Execution Engine 1020, in a manner described herein. The HDD could also store Application Definitions files 1050, log files etc. that is necessary to the AEE.

The Application Execution Engine 1020 may have various modules configured to perform different functions. In one embodiment, there is an Event Engine 1022 designed for efficient processing of streams of events, providing efficient service of events coming from multiple sources at the same or different time.

In one embodiment, there is Flow Processor 1024 to process and execute the actions defined in the process flow definition file according to the actual requirements of the application, the process flow consists of executable actions connected as Directed Acyclic Graph (DAG) in which actions are defined as nodes and transition among actions are defined as edges. The Flow Processor 1024 also provides various transition capabilities among actions with one or more of logical checking, conditional looping, asynchronized waiting to enable advanced process execution.

In one embodiment, there is Event Handler 1026 to process and execute the events defined in the application definition file according to the actual requirements of the application, the Event Handler 1026 provides the functions to initialize the handlers related with each type of event, provide necessary preprocessing and postprocessing of the event thus to simplify the actual event handling logic to be processed by different processors, certain processors could be loaded via plugins thus the AEE is easy to extend.

In one embodiment, there is Schema Processor 1028 responsible for the data schema management, including schema loading from storage disk, mapping between different attributes, validating the actual values against the define schema, etc. The Data Transformer 1030 transforms the data from one format to other, or calculate the output value based on the input data and corresponding formula defined in the application definition files. The Thread Manager 1032 manages the thread creation, execution and teardown thus to enable asynchronized processing of events, actions, etc. to improve the system throughput.

In one embodiment, there is Plugin Manager 1034 to manage the plugins for additional functionalities to the AEE and be loaded into memory only when necessary. 3 plugins are listed as examples, such as OpenAPI Plugin 1036, GraphQL Plugin 1038, Protobuf Plugin 1040. more plugins can be added for different types of protocol specification or for different functionalities, and the AEE loads the plugin only when it is required in the application definition files. The OpenAPI plugin processes the OpenAPI specification, a GraphQL plugin supports the GraphQL specifications, while a Protobuf plugin handles the Protobuf definition files. There could be multiple plugins for same protocol but with divided function, e.g., an OpenAPI Consumer plugin may only process the OpenAPI specification as the consumer side, while an OpenAPI Producer plugin processes the OpenAPI specification as the producer side. Extra functionalities can also be implemented as plugin, e.g., a security augment OpenAPI plugin provides further security enhanced features on top of the OpenAPI server plugin, a generic rate limiting plugin provides request throttling for all server-side plugins.

In one embodiment, the Application Definitions files 1050 include configurations (e.g., Environmental Parameters 1052, Certificates 1058), API specifications (e.g., API Specifications 1056), various definition files (Flow Definitions 1054, Schema Definitions 1060, Connection Definitions 1062) etc. that is specific to each application logic, which the application logic is described via the definition files, without the need of developing source codes for each application. However, it should be apparent that the Application Definitions files listed in the present teachings are for illustration purposes, those who are skilled in the art can organize the definition files in a different way without departing from the scope and spirit of the described embodiments, e.g., combining definition files in one master file, restructuring the attributes or value formats in the definition file, or even dynamically generating the content via a program, etc.

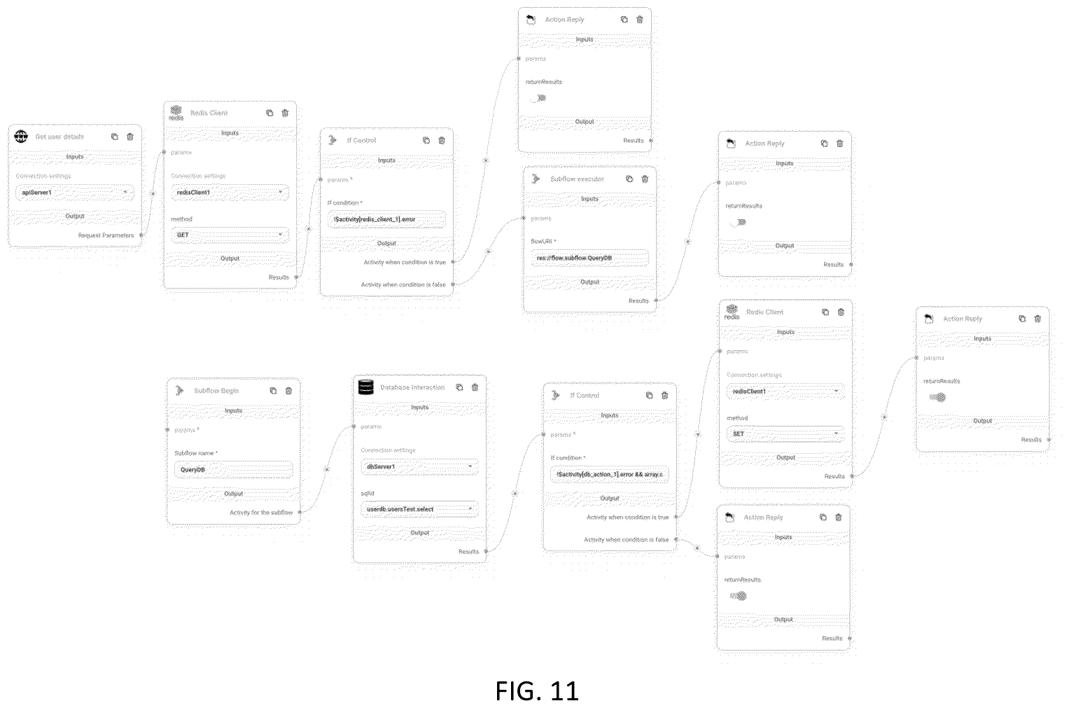

FIG. 11 presents an exemplary flowchart designer user interface portal allowing the developer to visually compose flowchart by dragging and dropping nodes, connecting the nodes, defining the parameters for each node based on the business logic for each flow. The exemplary flowchart includes a main flow and one sub-flow definition, each flow is composed of multiple nodes that each node is to perform specific action, for example, the “Get user details” node is to listen for incoming “GetUserDetail” request based on the API specification, which includes server side logic of the API specification that includes receiving the request packet, decoding and validating the data schema, and pass necessary parameters as output for its next hops to process. The “Redis Client” node is to fetch the user records from its internal memory cache based on the user name provided by the “Get user details”. By using the flowchart designer, the developer can quickly implement the service logics by adding or modifying the nodes, inputting necessary parameters, without the need to write codes in program languages such as Java, C, Go, Python and etc.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A computer-implemented method for API driven application development and execution, wherein the method comprises:
Defining, at the development phase, based on the protocol and functionality specification(s), the expected service behaviors with one or more process flows and storing the definition results in storage device;
Loading, upon application execution, the application definitions from the storage device and validating the correctness and completeness of the definitions;
Initiating the event process engine by linking the methods, operations defined in the protocol specification(s) with corresponding process flow identifier(s) associated with sequences of activities, service calls;
Determining the execution mode for each process flow.

2. The computer-implemented method of claim 1, upon determining a process flow to run in the producer mode, wherein the method further comprises:
Converting, dynamically in the process memory, the protocol specification into event handlers and registering in the event process engine with the process flow definition;
Establishing, based on definition, one or more server sockets to listen for incoming events over the networks;
Upon receiving incoming events, decoding the received packets, associating with corresponding event handlers, validating the request data against the data schemas defined in the protocol specification;
Upon successful validation, triggering the event process engine to execute the associated process flow, converting the returned success flow execution results into the response format defined in the protocol specification, and returning the response messages to the requesting party;
Upon failed validations or failed flow results, generating an error response message according to the protocol specification and returning the error response to the requesting party.

3. The computer-implemented method of claim 1, upon determining a process flow to run in the consumer mode, wherein the method further comprises:
Converting, dynamically in the process memory, the protocol specification into action handler and registering in the event process engine with the process flow definition;
Establishing, based on definition, network socket(s) to the specified component(s), or selecting a client socket from established connection pool(s);
Upon executed by the process flow, collecting and transforming the parameters, creating the request packets based on the data schemas defined in the protocol specification, and sending to the specified component over the selected client socket(s);
Upon receiving the response packet, decoding the response packet, identifying the corresponding process flow identifier for the respond handling, validating the response content against the protocol specification;
Upon successful validation, converting the returned results into the format required by the next hop of the process flow, triggering the event process engine to resume the remaining process flow;
Upon failed validations, results or exceptions, triggering the exception or error handling to complete the remaining process flow.

4. The computer-implemented method of claim 1, wherein the process flow consists of executable actions connected as Directed Acyclic Graph (DAG) where actions are defined as nodes and transition among actions are defined as edges.

5. The computer-implemented method of claim 4, wherein transition among actions includes computer logical conditions checking, iteration, sub-flow processing, exception handling, synchronized or asynchronized handling, with transition parameters calculated statically or dynamically.

6. The computer-implemented method of claim 4, wherein action definitions include references to executable functions, action parameters, input attributes, output attributes, attribute schemas and mapping rules.

7. The computer-implemented method of claim 1, wherein the application definitions comprise system parameters, process flow definitions, protocol specifications, connectivity definition to other components, any combination thereof.

8. The computer-implemented method of claim 1, wherein the database operations are written as parameterized queries, identified with unique Id and executed by relevant event or action handler(s) with parameters being inferred and calculated dynamically with values from the computer memory.

9. The computer-implemented method of claim 1, wherein the application includes one or more specifications in either same or different protocols, and implemented as libraries embedded in the execution engine, or as external plugins loaded by the application during runtime.

10. The computer-implemented method of claim 1, wherein the execution mode for each protocol in the application is independent, can be consumer, producer or both modes.

11. A system comprising:
a memory to store instructions;
a processor to execute instructions;
a network interface coupled to the processor to enable communication over a network;
an application execution engine software stored in the storage device, wherein an execution of the software by the processor configures the computing device to perform acts comprising:
Loading, upon application execution, the application definitions from the storage device or via the network interface, where the definitions include protocol specifications, process and flow definitions based on the business requirement;
Validating the correctness and completeness of the definitions;
Initiating the event process engine by linking the methods, operations defined in the protocol specification(s) with corresponding process flow identifier(s) associated with sequences of activities, service calls;
Determining the execution mode for each process flow.

12. The system of claim 11, upon determining a process flow to run in the producer mode, wherein the method further comprises:
Converting, dynamically in the process memory, the protocol specification into event handlers and registering in the event process engine with the process flow definition;
Establishing, based on definition, one or more server sockets to listen for incoming events over the networks;
Upon receiving incoming events, decoding the received packets, associating with corresponding event handlers, validating the request data against the data schemas defined in the protocol specification;
Upon successful validation, triggering the event process engine to execute the associated process flow, converting the returned success flow execution results into the response format defined in the protocol specification, and returning the response messages to the requesting party;
Upon failed validations or failed flow results, generating an error response message according to the protocol specification and returning the error response to the requesting party.

13. The system of claim 11, upon determining a process flow to run in the consumer mode, wherein the method further comprises:
Converting, dynamically in the process memory, the protocol specification into action handler and registering in the event process engine with the process flow definition;
Establishing, based on definition, network socket(s) to the specified component(s), or selecting a client socket from established connection pool(s);
Upon executed by the process flow, collecting and transforming the parameters, creating the request packets based on the data schemas defined in the protocol specification, and sending to the specified component over the selected client socket(s);
Upon receiving the response packet, decoding the response packet, identifying the corresponding process flow identifier for the respond handling, validating the response content against the protocol specification;
Upon successful validation, converting the returned results into the format required by the next hop of the process flow, triggering the event process engine to resume the remaining process flow;
Upon failed validations, results or exceptions, triggering the exception or error handling to complete the remaining process flow.

14. The system of claim 11, wherein the process flow consists of executable actions connected as Directed Acyclic Graph (DAG) where actions are defined as nodes and transition among actions are defined as edges.

15. The system of claim 14, wherein transition among actions includes computer logical conditional checking, iteration, sub-flow processing, exception handling, synchronized or asynchronized handling, with transition parameters calculated statically or dynamically.

16. The system of claim 14, wherein action definitions include references to executable functions, action parameters, input attributes, output attributes, attribute schemas and mapping rules.

17. The system of claim 11, wherein the application definitions comprise system parameters, process flow definitions, API specifications, connectivity definition to other components, any combination thereof.

18. The system of claim 11, wherein the application includes one or more specifications in either same or different Protocols, implemented as libraries embedded in the execution engine, or as external plugins loaded by the application during runtime.

19. The system of claim 11, wherein the execution mode for each protocol in the application is independent, can be consumer, producer or both modes.

20. The system of claim 11, wherein the system includes optional flowchart design graphic user interface to visually design, implement and configure the actions, transitions, parameters for each application flow.
